(19) United States
(12) Patent Application Publication
(10) Pub. No.: US 2013/0061863 A1
(43) Pub. Date: Mar. 14, 2013

(54) Hair Care Kits and Compositions

(71) Applicant: Gary Grey, New York, NY (US)

(72) Inventor: Gary Grey, New York, NY (US)

(21) Appl. No.: 13/230,299

(22) Filed: Sep. 12, 2011

(51) Int. Cl. B65D 21/00; A61Q 5/12; A61Q 5/02

(52) U.S. Cl. 132/200; 206/223; 132/314

(57) ABSTRACT

The present invention is directed to kits comprising multiple containers packaged in conjunction with each other, which provide convenience to a user when applying multiple hair products to the user's hair. A first container containing a first composition is packaged in contact with a second container containing a second composition, such that a user can easily purchase and transport the two containers together and use both as part of a hair care regimen.

### TECHNICAL FIELD

This invention relates generally to hair compositions, kits and methods for treating hair.

### BACKGROUND OF THE INVENTION

Consumers of hair products often desire to use multiple products in conjunction with each other, or as part of a hair care routine that includes application of more than one product. Often, a user of such products will buy multiple products in separate containers, and use them together, either sequentially or by mixing the contents of two or more containers and then applying the mixture to the hair.

It has been found that purchasing multiple containers of different hair products can pose an issue of inconvenience for the user. For example, multiple products in packaging of different sizes and shapes often present problems of transport and storage. Multiple products take up more space on a store shelf at the point of purchase, take longer to select, might be found on different shelves and in different parts of the store or website and purchase and take up greater space on a user's bathroom counter before use.

Attempts have been made to streamline the user's experience by mixing multiple ingredients into a single container for a one-step application. However, this is often not desirable, as the components may mix before application, diminishing their efficacy on the user's hair. For various reasons, it is often preferable to keep the components separate during storage and before purchase and application to the user's hair. Further, kits have been sold wherein separate components are packaged in different packages within the kit, for a user to combine at use. However, such kits tend to include excessive packaging materials, are difficult to manufacture and include excessive wasted space (for example, a box or carton containing multiple bottles). Such unnecessary packaging contributes to higher costs and greater environmental impact.

The present invention provides the advantage of a kit comprising multiple containers for multiple hair treatments in conjunction with each other by a user, with convenient packaging that facilitates ease of manufacture, purchase, transport and use by the user.

### SUMMARY OF THE INVENTION

The present invention is directed, in certain embodiments, to a kit comprising:
(a) a first container containing a first composition, the first container comprising a first lid and a first bottom surface;
(b) a second container containing a second composition, the second container comprising a second lid, the second lid comprising a second top surface having a size and shape complementary to that of the first bottom surface;
wherein the first container and the second container are packaged in conjunction with each other such that the first bottom surface and the second top surface contact each other.

The present invention is directed, in other embodiments, to a kit comprising:
(a) a first container containing a first composition, the first container comprising a first lid and a first bottom surface, the first bottom surface forming a second lid;
(b) a second container containing a second composition, the second container comprising a top opening, the top opening having a size and shape complementary to that of the first bottom surface, and being configured to removably attach to the first bottom surface;
wherein the first container and the second container are packaged in conjunction with each other such that the first bottom surface and the second top surface contact each other.

The present invention is directed, in other embodiments, to a method of applying a first composition and a second composition to hair, the method comprising:
(a) obtaining the first composition by removing a first lid from a first container, wherein the first container comprises a first bottom surface, and contains the first composition;
(b) removing a portion of the first composition and applying it to the hair;
(c) obtaining a second composition by removing a second lid from a second container, wherein the second container comprises a second top surface having a size and shape complementary to that of the first bottom surface, and contains the second composition; and
(d) removing a portion of the second composition and applying it to the hair; wherein the first container and second container are packaged in conjunction with each other, such that the first bottom surface and the second top surface are in contact with each other before the second lid is removed from the second container.

### BRIEF DESCRIPTION OF THE FIGURES

FIG. 1 is a view of an exemplary embodiment of the present invention.

FIGS. 2a and 2b depict a first container and a second container according to another embodiment of the present invention.

FIGS. 3a and 3b depict a first container and a second container according to another embodiment of the present invention.

### DETAILED DESCRIPTION OF THE INVENTION

As described herein, the present invention is directed to kits that provide hair compositions in convenient packaging for purchase, transport, storage and use.

In certain embodiments, the kits of the present invention provide a first container having a first bottom surface and a second top surface having a size and shape complementary to that of the first bottom surface, such that the first bottom surface and the second top surface are in contact with each other. As used herein, “complementary” means that the two surfaces have a similar size and corresponding shape that permit them to be placed in contact with each other in a manner wherein they touch or fit together. In some embodiments, in addition to being complementary, the two surfaces may generally stay in contact when not further disturbed. The present invention contemplates embodiments wherein the first bottom surface and the second top surface are in any contact with each other, in partial contact, or entirely in contact with each other.

In certain embodiments, the second top surface comprises a lip around at least a portion of its outer perimeter, and the first bottom surface comprises a groove around at least a portion of its outer perimeter, wherein the lip corresponds to and mates with the groove when the first bottom surface touches the second top surface. As used herein, the terms “correspond to” and “mates” may mean that the lip and groove are generally complementary shapes, such that when put into contact with each other, they touch; in various embodiments, the touching may be such that they two pieces are easily separated, or such that they snap or fit together in a tight configuration.

In certain embodiments, the first bottom surface and the second top surface are removably attached to each other; as used herein, “removably attached” means that a user can easily detach the two using only manual pressure or force. For example, removable attachment may be made via, for example, a magnet, a hook and loop attachment (e.g., Velcro®), temporary adhesive, wrapping material such as, but not limited to, a shrink wrapped label, a clasp, an easily unengaged screw or a binary attachment that is made by turning the top container and bottom container relative to each other to engage a mechanism for holding the two together, which mechanism can be separated easily by a user's hands.

In certain embodiments, the first bottom surface and the second bottom surface are permanently attached to each other; as used herein, “permanently attached” means that a user cannot easily detach the two using only manual pressure force—that is, removal is essentially impossible or can be accomplished only using special tools. For example, with permanent adhesive, glue, soldering, screws or in a configuration where both are molded from a single piece of material and constitute a unified piece.

In certain embodiments of the invention, greater ease and convenience of use can be realized, since the user can open one of the containers at a time, leaving the other covered. For example, the first lid can be removed to gain access to the first composition without removing the second lid; conversely, the second lid can be removed to gain access to the second composition while keeping the first lid closed on the first container. In this manner, the kits and products of the present invention are easier to use than those known in the art, and in certain embodiments may be used by a user with only a single hand.

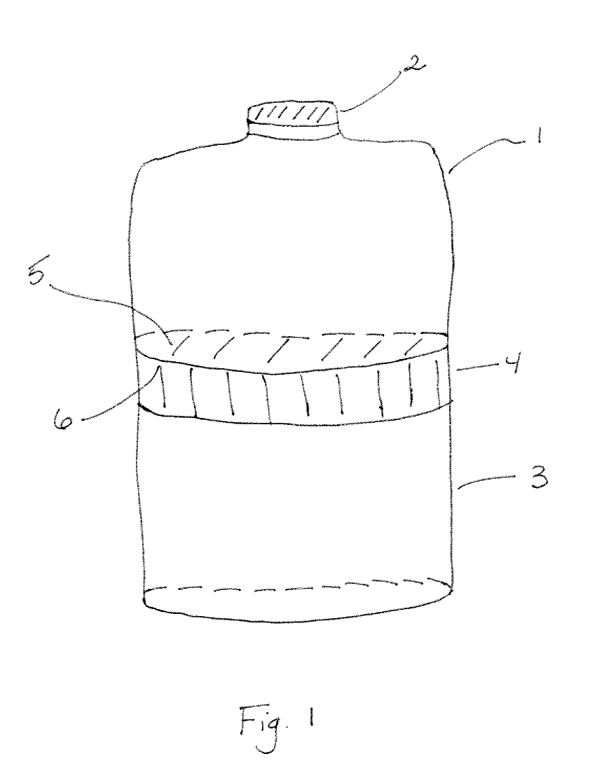

FIG. 1 shows a certain embodiment of the present invention, depicting a first container 1 comprising a first lid 2, packaged in conjunction with a second container 3 having a second lid 4. The first bottom surface 5 and the second top surface 6 are complementary to each other and in contact with each other.

It is important to note that the first bottom surface and second top surface may be of any size, shape or configuration that are complementary and that permit them to be in contact with each other. As contemplated in the embodiments herein, the surfaces touch each other to the extent necessary to provide a desirable packaging—that is, the two surfaces “fit” in a way that is stable, convenient and desirable for storage and use.

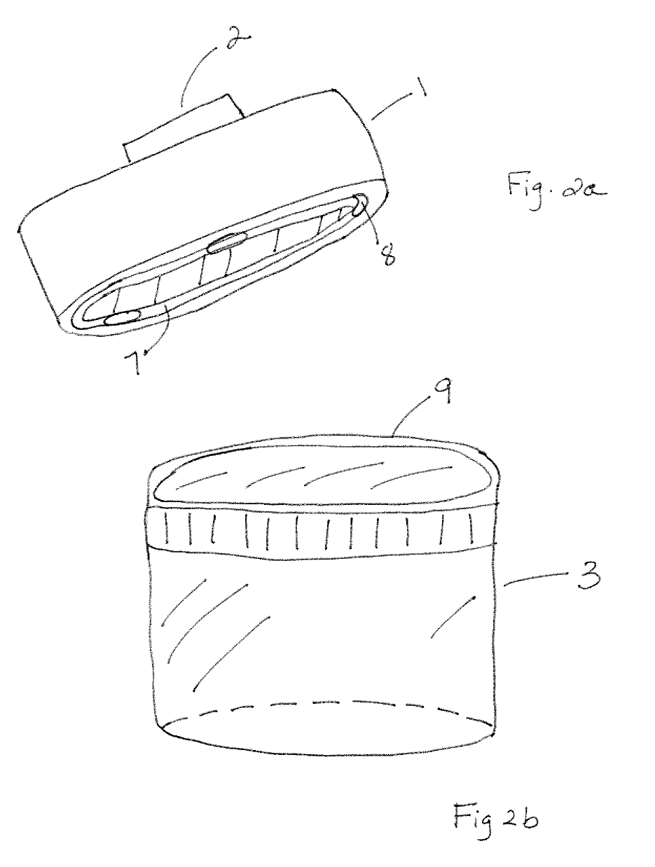

FIGS. 2a and 2b show the first container and second container in separated form, in another embodiment of the present invention. In FIG. 2a, the first container 1 can be seen from a bottom view, and is shown to include at least one lip 7 disposed around at least a portion of the edge of the first bottom surface 5. In the embodiment shown in FIG. 2a, the first container further optionally comprises one or more projections 8, disposed about the outer edge of the first bottom surface 5 and creating further surface area for contacting with the groove 9 of the second top surface of the second lid. While FIG. 2a shows three separate projections 8, all equally spaced about the outer edge of the first bottom surface 5, the invention is not so limited; that is, in other embodiments, there can be any number of projections disposed in any manner that facilitates contact of the two containers. In the embodiments shown in FIGS. 2a and 2b, the first container 1 and second container 3 can thus be packaged in conjunction by fitting the lip of the first bottom surface into the groove of the second top surface of the second lid. FIGS. 1-3 show the interior of the first and second containers for illustrative purposes, although in various embodiments, they can be made of translucent or opaque material. In other embodiments (not pictured), the positions of the lip, optional projections and groove may be switched; that is, the lip and optional projections may be on the second surface, and the groove may be on the first bottom surface.

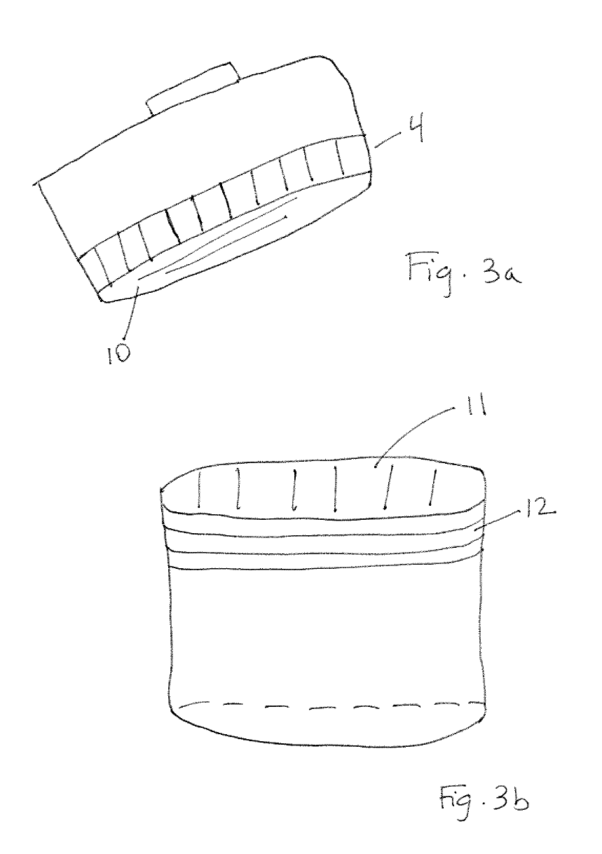

FIGS. 3a and 3b show another embodiment of the present invention, where the second lid 4 is permanently fused to the first bottom surface. Such permanent attachment can be made via, for example, permanent adhesive, soldering, clamping or the like. In certain further embodiments, both the first container 1 and the second lid 4 are molded from a single piece of material such that they constitute a single unified piece. The advantage of such a configuration is that a user can have convenient access to two ingredients provided by a kit in accordance with certain embodiments of the invention. The user can turn the first lid to obtain access to the first composition; further, by turning the first container, the second lid can be detached (for example, unscrewed) in conjunction with such movement, thereby accessing the second composition as well. As can be seen in FIG. 2a, the second lid portion of the first bottom surface comprises one or more first threads 10.

In FIG. 2a, the second container 3 has a top opening 11, providing easy access to the composition within. Further, the outer edge of the top of the second container may comprise one or more second threads 12 that engage and mate with the one or more first threads 10 to connect the first container to the second container.

It is important to note that in various embodiments, each of the first bottom surface and the second top surface may be substantially flat, or may be rounded, curved, angled or in any other configuration that is complementary to the other, furthers their contact and forms a kit with desirable packaging.

In certain embodiments, the containers of the present invention may be made of any material that is inert and useful for packaging hair care and personal care products—for example, any polymeric material such as plastic material (polyethylene, polypropylene, polystyrene), metal, glass and the like. In certain embodiments, any part of the kits of the present invention may be made of recyclable, biodegradable or otherwise environmentally friendly material. In certain embodiments, one or both of the first lid and the second lid may comprise a rougher surface than the surface of the first and second containers; for example, vertical scoring to provide better friction for a user's hand to grip. This can be seen, for example, in FIGS. 1-3, where the outer surface of the second lid is vertically scored to assist a user in gripping and twisting the lid to open the second container.

In the embodiments of the invention contemplated herein, the first container and second container include a first composition and a second composition, respectively. As used herein, “composition” refers to any personal composition, for example, a hair composition including shampoo, conditioner, hair relaxer, neutralizer, activator, lotion or the like. Thus, in certain embodiments, the first container may contain, for example, a shampoo, and the second container may contain a conditioner; or the first container may contain, for example, a relaxer, and the second container may contain a hair neutralizer or conditioner. In other embodiments, the first composition is a shampoo and the second composition is a hair relaxer, neutralizer or conditioner. Any similar combinations may be useful and desirable for a user, and are contemplated by the present invention. The compositions of the present invention can be in any form including liquid, cream, powder, gel, mousse, foam, suspension or even individually packaged portions such as ampoules, capsules or sachets.

Further embodiments are contemplated in the present invention, wherein the second container in turn comprises a second bottom surface, packaged in conjunction with (or provided as a single, unified structure with) a third lid that is complementary to the second bottom surface, and a third container containing a third composition, and so on.

The kits of the present invention may be packaged in a manner that is more environmentally friendly and uses fewer materials than the kits of the present art. For example, in certain embodiments, the first and second container are wrapped in whole or in part in shrink wrap packaging. In certain embodiments, the shrink wrap packaging may hold the two containers together, and when removed allows for separation of the two containers. In other embodiments, a sleeve made of paper, cardboard of polymeric material may encompass the two containers, and may be slid off the containers prior to use. The label or packaging may bear information regarding the kit, the components therein, the compounds in each of the two containers, instructions for their application and other information that may be beneficial to the user. The labeling and wrapping also advantageously present the kit with a much smaller “footprint” on the shelf at the point of sale, and in the user's home after purchase, than the kits known in the art. One advantage of the kits of the present invention are their efficient presentation, which allows a seller to use less shelf space to present them for sale and provides an easier shopping experience for the buyer.

The present invention further contemplates methods of applying a first composition and a second composition to human hair, comprising the steps of (a) obtaining the first composition by removing a first lid from a first container, wherein the first container comprises a first bottom surface, and contains the first composition; (b) removing a portion of the first composition and applying it to the hair; (c) obtaining a second composition by removing a second lid from a second container, wherein the second container comprises a second top surface that is complementary to the first bottom surface, and contains the second composition; and (d) removing a portion of the second composition and applying it to the hair; wherein the first container and second container are packaged in conjunction with each other, such that the first bottom surface and the second top surface are in contact with each other before the second lid is removed from the second container. In certain embodiments, the first bottom surface and the second top surface are in contact with each other immediately before the second lid is removed from the second container.

In certain embodiments, the first container and the second lid are together a unified structure, such that the second lid can be detached and removed from the second container by gripping and twisting the first container. In certain embodiments, the user may be able to use the kits of the present invention by using a single hand.

As discussed herein, the kits and methods of the present invention provide for many advantages: among them, efficiency of use, less environmental impact and packaging waste, a smaller “footprint” on both a seller's shelf before sale and a user's countertop after sale, lower price due to less wasted packaging material and ease of storage and transport due to efficient size and packaging.

Although the present invention has been described in relation to particular embodiments thereof, these embodiments and examples are merely exemplary and not intended to be limiting. Many other variations and modifications and other uses will become apparent to those skilled in the art. The present invention should, therefore, not be limited by the specific disclosure herein, and may be embodied in other forms not explicitly described here, without departing from the spirit thereof.

What is claimed is:

1. A kit comprising:
(a) a first container containing a first composition, the first container comprising a first lid and a first bottom surface;
(b) a second container containing a second composition, the second container comprising a second lid, the second lid comprising a second top surface having a size and shape complementary to that of the first bottom surface;
wherein the first container and the second container are packaged in conjunction with each other such that the first bottom surface and the second top surface contact each other.

2. The kit of claim 1, wherein the first bottom surface is substantially flat, rounded, curved or angled.

3. The kit of claim 1, wherein the second top surface is substantially flat, rounded curved or angled in a manner complementary to the first bottom surface.

4. The kit of claim 1, wherein the first bottom surface and the second top surface are entirely in contact with each other.

5. The kit of claim 1, wherein the second top surface comprises a lip around at least a portion of its outer perimeter, and the first bottom surface comprises a groove around at least a portion of its outer perimeter, wherein the lip corresponds to and mates with the groove when the first bottom surface touches the second top surface.

6. The kit of claim 1, wherein the second top surface comprises a groove around at least a portion of its outer perimeter, and the first bottom surface comprises a lip around at least a portion of its outer perimeter, wherein the groove corresponds to and mates with the lip when the first bottom surface touches the second top surface.

7. The kit of claim 1, wherein the first bottom surface and the second top surface are removably attached to each other.

8. The kit of claim 1, wherein the first bottom surface and the second top surface are permanently attached to each other.

9. The kit of claim 1, wherein the first composition is a hair relaxer and the second composition is a hair neutralizer or conditioner.

10. The kit of claim 1, wherein the first composition is a shampoo and the second composition is a hair relaxer, neutralizer or conditioner.

11. The kit of claim 1, wherein one or more of the first container and second container comprises polymeric material.

12. A kit comprising:
(a) a first container containing a first composition, the first container comprising a first lid and a first bottom surface, the first bottom surface forming a second lid;
(b) a second container containing a second composition, the second container comprising a top opening, the top opening having a size and shape complementary to that of the first bottom surface, and being configured to removably attach to the first bottom surface;
wherein the first container and the second container are packaged in conjunction with each other such that the first bottom surface and the second top surface contact each other.

13. The kit of claim 12, wherein the top opening removably attaches to the first bottom surface by threading into the second lid.

14. The kit of claim 12, wherein the second lid comprises one or more first threads and the second top surface comprises one or more second threads that engage and mate with the one or more first threads to connect the first container and the second container.

15. The kit of claim 12, wherein the first composition is a hair relaxer and the second composition is a hair neutralizer or conditioner.

16. A method of applying a first composition and a second composition to human hair, the method comprising:
(a) obtaining the first composition by removing a first lid from a first container, wherein the first container comprises a first bottom surface, and contains the first composition;
(b) removing a portion of the first composition and applying it to the hair;
(c) obtaining a second composition by removing a second lid from a second container, wherein the second container comprises a second top surface having a size and shape complementary to that of the first bottom surface, and contains the second composition; and
(d) removing a portion of the second composition and applying it to the hair;
wherein the first container and second container are packaged in conjunction with each other, such that the first bottom surface and the second top surface are in contact with each other before the second lid is removed from the second container.

17. The method of claim 16, wherein the first container and the second lid are together a unified structure, such that when the second lid can be removed from the second container by gripping and twisting the first container.
